(19) United States
(12) Patent Application Publication
(10) Pub. No.: US 2024/0305555 A1
(43) Pub. Date: Sep. 12, 2024

(54) WIRELESS COMMUNICATION MANAGEMENT APPARATUS, WIRELESS COMMUNICATION MANAGEMENT METHOD, AND WIRELESS COMMUNICATION MANAGEMENT PROGRAM

(71) Applicant: NIPPON TELEGRAPH AND TELEPHONE CORPORATION, Tokyo (JP)

(72) Inventors: Shoko SHINOHARA, Musashino-shi (JP); Yasuhiko INOUE, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/269,009

(22) PCT Filed: Dec. 25, 2020
(86) PCT No.: PCT/JP2020/048626

§ 371 Date: Jun. 22, 2023

(51) Int. Cl. H04L 45/121; H04L 45/00; H04L 45/122

(52) U.S. Cl. CPC H04L 45/121; H04L 45/122; H04L 45/20

(57) ABSTRACT

A wireless communication management apparatus (100) according to one aspect of the present invention includes a path calculation unit (152) that, on the basis of wireless environment information collected from one or more relay base stations (210) and a plurality of terminals (300) configured to wirelessly communicate with a root base station (200), calculates one or more path candidates which are connectable paths that can be taken as a network configuration by multi-hop communication and in which a traffic amount of each relay base station (210) included in the connectable paths is less than a threshold, and a determination unit (153) that determines one of the one or more path candidates as an optimal path.

### TECHNICAL FIELD

An embodiment relates to a wireless communication management apparatus, a wireless communication management method, and a wireless communication management program.

### BACKGROUND ART

A wireless communication system including a base station and a terminal is known.

A typical example of a wireless communication system is a wireless local area network (LAN) for public use. As a wireless LAN for public use, for example, a use case in which data is transmitted from a base station to a public computer terminal and a smartphone terminal is assumed.

On the other hand, in recent years, a wireless LAN for industrial use has appeared. As a wireless LAN for industrial use, for example, a use case in which data measured by an Internet of things (IoT) terminal is transmitted to a base station is assumed.

### CITATION LIST

### Non Patent Literature

Non Patent Literature 1: ARIB STD-T108 1.3, “920 MHZ-Band Telemeter, Telecontrol and Data Transmission Radio Equipment and Standards”, Apr. 12, 2019
Non Patent Literature 2: IEEE Std 802.11ah TM-2016 (IEEE Standard for Information technology—Telecommunications and information exchange between systems Local and metropolitan area networks—Specific requirements, Part 11: Wireless LAN Medium Access Control (MAC) and Physical Layer (PHY) Specifications, Amendment 2: Sub 1 GHz License Exempt Operation, IEEE Computer Society, 7 Dec. 2016

### SUMMARY OF INVENTION

### Technical Problem

In a case where a radio frame is transmitted by a wireless communication network by multi-hop communication between a terminal and a base station serving as a starting point via a relay base station (mesh access point) or the like, it is necessary to select an optimal communication path (also simply referred to as path) including a relay. In addition, in a case where a radio frame is transmitted in a domestic 920 MHz band, there is a constraint on the transmittable time due to the Radio law or the like, and thus, it is necessary to consider not only the propagation environment of each terminal, but also the constraint on the transmittable time of a relay base station. When a plurality of terminals select a path via the same relay base station without considering the transmittable time of the relay base station, there is a possibility that the traffic amount in each terminal decreases due to the constraint of the transmittable time of the relay base station, and throughput of the entire network decreases.

The present invention has been made in view of the above circumstances, and an object thereof is to provide means for managing optimal route selection.

### Solution to Problem

A wireless communication management apparatus of one aspect includes a path calculation unit that, on the basis of wireless environment information collected from one or more relay base stations and a plurality of terminals configured to wirelessly communicate with a root base station, calculates one or more path candidates which are connectable paths that can be taken as a network configuration by multi-hop communication and in which a traffic amount of each relay base station included in the connectable paths is less than a threshold, and a determination unit that determines one of the one or more path candidates as an optimal path.

### Advantageous Effects of Invention

According to an embodiment, means for managing optimal path selection may be provided.

### BRIEF DESCRIPTION OF DRAWINGS

FIG. 1 is a diagram illustrating an example of a configuration of a communication system according to the present embodiment.

FIG. 2 is a block diagram illustrating an example of a hardware configuration of a wireless communication management apparatus according to the present embodiment.

FIG. 3 is a block diagram illustrating an example of a hardware configuration of a base station according to the present embodiment.

FIG. 4 is a block diagram illustrating an example of a hardware configuration of a terminal according to the present embodiment.

FIG. 5 is a block diagram illustrating an example of a functional configuration of the wireless communication management apparatus according to the present embodiment.

FIG. 6 is a block diagram illustrating an example of a functional configuration of a root base station according to the present embodiment.

FIG. 7 is a block diagram illustrating an example of a functional configuration of a relay base station according to the present embodiment.

FIG. 8 is a block diagram illustrating an example of a functional configuration of the terminal according to the present embodiment.

FIG. 9 is a block diagram illustrating details of a control information generation unit according to the present embodiment.

FIG. 10 is a flowchart illustrating an example of a wireless communication management operation in the wireless communication management apparatus according to the present embodiment.

FIG. 11 is a flowchart illustrating optimal path determination processing of the wireless communication management apparatus according to the present embodiment.

FIG. 12 is a flowchart illustrating calculation processing of a minimum hop count according to the present embodiment.

FIG. 13 is a diagram illustrating an example of a management table of RSSI values according to the present embodiment.

FIG. 14 is a diagram illustrating an example of a result of determining the connectivity according to the present embodiment.

FIG. 15 is a diagram illustrating an example of a management table of the minimum hop count according to the present embodiment.

FIG. 16 is a flowchart illustrating path candidate calculation processing according to the present embodiment.

FIG. 17 is a diagram illustrating an example of a management table illustrating connectable devices according to the present embodiment.

FIG. 18 is a conceptual diagram illustrating an example of one or more connectable paths according to the present embodiment.

FIG. 19 is a conceptual diagram illustrating another example of one or more connectable paths according to the present embodiment.

FIG. 20 is a diagram illustrating an example of a management table including maximum traffic amounts and an assumed traffic amounts according to the present embodiment.

FIG. 21 is an example of a management table illustrating a determination result regarding traffic according to the present embodiment.

FIG. 22 is a diagram illustrating an example of a management table including maximum traffic amounts and assumed traffic amounts when the assumed traffic amount is decreased according to the present embodiment.

FIG. 23 is a diagram illustrating a management table illustrating a determination result regarding traffic when the assumed traffic amount is decreased according to the present embodiment.

FIG. 24 is a flowchart illustrating details of transmission power control according to the present embodiment.

### DESCRIPTION OF EMBODIMENTS

Hereinafter, an embodiment will be described with reference to the drawings. Note that in the following description, components having the same function and configuration are denoted by the same reference numerals. In addition, when distinguishing among a plurality of components having a common reference sign, the component is distinguished by an additional reference sign (e.g., hyphen and number such as “−1”) attached after the common reference sign.

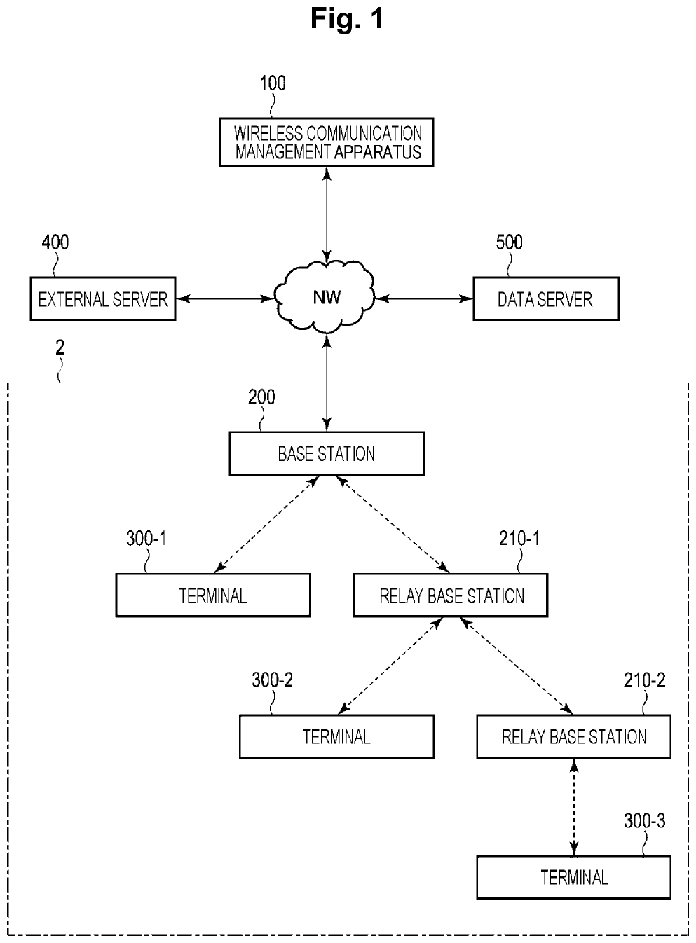

A configuration of a communication system according to an embodiment will be described. FIG. 1 is a block diagram illustrating an example of the configuration of the communication system according to the embodiment.

As illustrated in FIG. 1, a communication system 1 is a system that manages a wireless environment of a wireless communication system 2. The communication system 1 includes a wireless communication management apparatus 100, a base station 200, relay base stations 210-1 and 201-2, a plurality of terminals 300-1, 300-2, and 300-3, an external server 400, and a data server 500. The base station 200, the relay base stations 210-1 and 201-2, and the plurality of terminals 300-1, 300-2, and 300-3 form the wireless communication system 2.

Hereinafter, the base station 200 may be referred to as “root base station”. Each of the relay base stations 210-1 and 201-2 may be simply referred to as “relay base station 210” unless otherwise distinguished. In addition, each of the root base station and the relay base stations 210-1 and 201-2 may be simply referred to as “base station” unless otherwise distinguished. Each of the plurality of terminals 300-1 to 300-3 may be referred to as “terminal 300” unless otherwise distinguished. Furthermore, the base station 200, the relay base station 210, and the terminal 300 may be collectively referred to as “device”.

The wireless communication system 2 is a wireless communication system for industrial use. The wireless communication system 2 is configured to use a frequency band (unlicensed band) that can be used without a wireless station license. In the wireless communication system 2, for example, a sub-GHz band is used as an unlicensed band. The sub-GHz band includes, for example, the 920 MHz band.

The wireless communication management apparatus 100 is an on-premises data processing server for managing a wireless environment of the wireless communication system 2. The wireless communication management apparatus 100 is configured to establish wired connection with the base station 200, the external server 400, and the data server 500 via, for example, a router or a hub (not illustrated) in a network NW.

The base station 200 is a master unit (AP: access point) of the wireless communication system 2. The base station 200 is configured to connect the terminal 300 and the wireless communication management apparatus 100 and connect the terminal 300 and the data server 500 via the network NW.

The relay base station 210 is configured to wirelessly connect the base station 200 and the terminal 300. The example of FIG. 1 illustrates a case where the relay base station 210 wirelessly connects the base station 200 and the terminal 300-2. In addition, the relay base stations 210 may be wirelessly connected with each other, and may operate as a so-called mesh AP. In the example of FIG. 1, the relay base station 210-1 may wirelessly connect to the relay base station 210-2. By forming the wireless communication network via the relay base station 210 in this manner, it is possible to construct the wireless communication system 2 in which the terminals 300 are distributed over a wider range.

The terminal 300 is a slave unit (STA: station) of the wireless communication system 2. The terminal 300 is, for example, an IoT terminal. The terminal 300 is configured to wirelessly connect to the base station 200 or the relay base station 210.

In the example of FIG. 1, the terminal 300-1 is configured to wirelessly connect to the base station 200. The terminal 300-2 is wirelessly connected to the relay base station 210-1, and the terminal 300-3 is wirelessly connected to the relay base station 210-2. Note that the present invention is not limited thereto, and the terminal 300-1 may be wirelessly connected to the relay base station 210-1, or the terminal 300-2 may be wirelessly connected to the base station 200, that is, for the wireless connection between the terminal 300 and the base station 200, an optimal path may be appropriately selected from a plurality of paths according to the propagation state of the terminal 300 and the base station, the constraint on transmission time, and the like.

The external server 400 is a server that stores information (external environment information) regarding the external environment of the wireless communication system 2.

The data server 500 is a server in which sensor information measured by the wireless communication system 2 is aggregated and stored. In addition, a management table in which information on the RSSI value and the information on the traffic amount of each device are aggregated may be stored.

Note that the wireless communication management apparatus 100 and the data server 500 may be integrally configured, and the wireless communication management apparatus 100 may include the data server 500. In addition, the wireless communication management apparatus 100 may be configured integrally with the root base station, the root base station may include the wireless communication management apparatus 100, and the root base station may perform processing of the wireless communication management apparatus 100.

Next, a hardware configuration of a main configuration in the communication system according to the embodiment will be described.

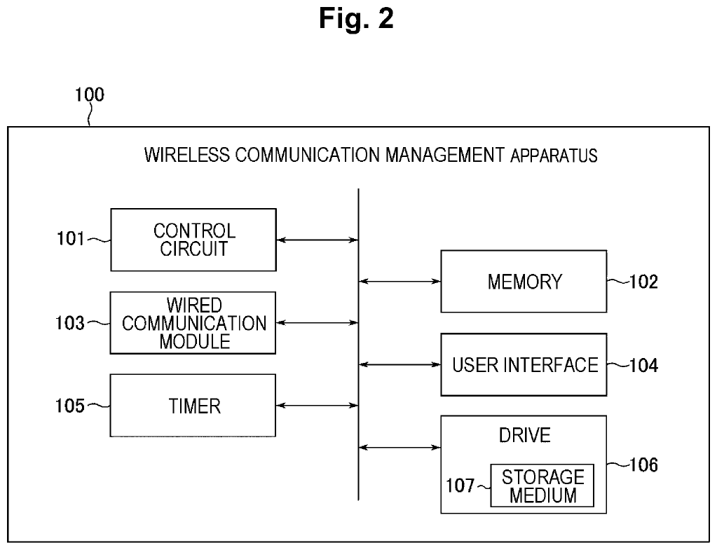

FIG. 2 is a block diagram illustrating an example of a hardware configuration of the wireless communication management apparatus according to the embodiment.

The wireless communication management apparatus 100 includes a control circuit 101, a memory 102, a wired communication module 103, a user interface 104, a timer 105, and a drive 106.

The control circuit 101 is a circuit that has overall control of the components of the wireless communication management apparatus 100. The control circuit 101 includes a central processing unit (CPU), a random access memory (RAM), a read only memory (ROM), and the like.

The memory 102 is an auxiliary storage device of the wireless communication management apparatus 100. The memory 102 includes, for example, a hard disk drive (HDD), a solid state drive (SSD), a memory card, and the like. The memory 102 stores various types of information used for a wireless communication management operation and a wireless communication management program. The wireless communication management program can be stored in the memory 102 by being transmitted from outside the wireless communication management apparatus 100 via the network NW.

The wireless communication management operation is a series of operations performed to appropriately manage a wireless communication environment in the wireless communication system 2. The wireless communication management program is a program for causing the control circuit 101 to perform the wireless communication management operation. Details regarding the wireless communication management operation will be described later.

The wired communication module 103 is a circuit used for transmission and reception of data by a wired signal. The wired communication module 103 is configured, for example, to conform to the TCP/IP hierarchical model. Specifically, for example, a configuration of the wired communication module 103 corresponding to the network interface layer is compliant with Ethernet. A configuration of the wired communication module 103 corresponding to the Internet layer is compliant with the Internet protocol (IP). A configuration of the wired communication module 103 corresponding to the transport layer is compliant with the transmission control protocol (TCP). A configuration of the wired communication module 103 corresponding to the application layer is compliant with the Secure shell (SSH).

The user interface 104 is a circuit for communicating information between the user and the control circuit 101. The user interface 104 includes an input device and a display device. The input device includes, for example, a touch panel, an operation button, and the like. The display device includes, for example, a liquid crystal display (LCD), an electroluminescence (EL) display, and the like. The user interface 104 converts an input (user input) from the user into an electrical signal, and then transmits the electrical signal to the control circuit 101.

The timer 105 is a circuit that measures time. For example, the timer 105 starts counting on the basis of a start instruction from the control circuit 101 (set). When the count value becomes equal to or larger than a threshold in the set state, the timer 105 notifies the control circuit 101 of a timeout (timeout). The timer 105 ends counting on the basis of an end instruction from the control circuit 101 (reset).

The drive 106 is a device for reading a program stored in a storage medium 107. The drive 106 includes, for example, a compact disk (CD) drive, a digital versatile disk (DVD) drive, and the like.

The storage medium 107 is a medium that accumulates information such as programs by electrical, magnetic, optical, mechanical, or chemical action. The storage medium 107 may store the wireless communication management program.

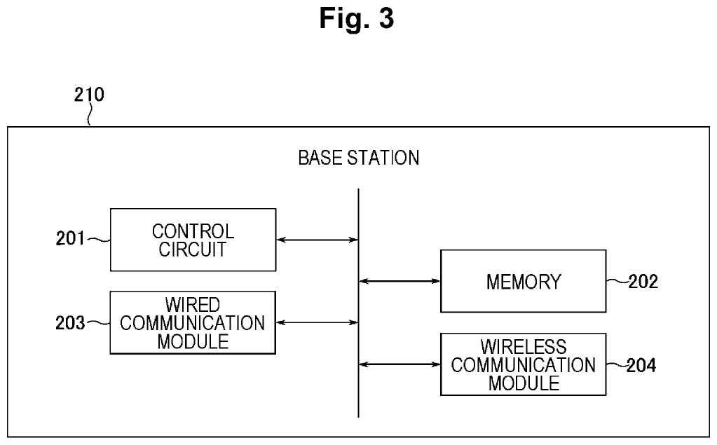

FIG. 3 is a block diagram illustrating an example of a hardware configuration of the base station according to the embodiment. Since the configuration of the root base station and the configuration of the relay base station 210 are similar, the base station 200 will be described as an example.

As illustrated in FIG. 3, the base station 200 includes a control circuit 201, a memory 202, a wired communication module 203, and a wireless communication module 204.

The control circuit 201 is a circuit that has overall control of the component of the base station 200. The control circuit 201 includes a CPU, a RAM, a ROM, and the like.

The memory 202 is an auxiliary storage device of the base station 200. The memory 202 includes, for example, an HDD, an SSD, a memory card, and the like. The memory 202 stores control information of the base station 200 generated by the wireless communication management apparatus 100 in the wireless communication management operation.

The wired communication module 203 is a circuit used for transmission and reception of data by a wired signal. The wired communication module 203 conforms to a protocol stack equivalent to that of the wired communication module 103. With this configuration, the wired communication module 203 can be connected to the wired communication module 103 by wire.

The wireless communication module 204 is a circuit used for transmission and reception of data by a wireless signal. The wireless communication module 204 is connected to an antenna (not illustrated). The wireless communication module 204 is configured, for example, to conform to the TCP/IP hierarchical model. Specifically, for example, a configuration of the wireless communication module 204 corresponding to the network interface layer is compliant with Institute of electrical and electronics engineers (IEEE) 802.11 ah. A configuration of the wireless communication module 204 corresponding to the Internet layer is compliant with the IP. A configuration of the wireless communication module 204 corresponding to the transport layer is compliant with the TCP. A configuration of the wireless communication module 204 corresponding to the application layer is compliant with the SSH.

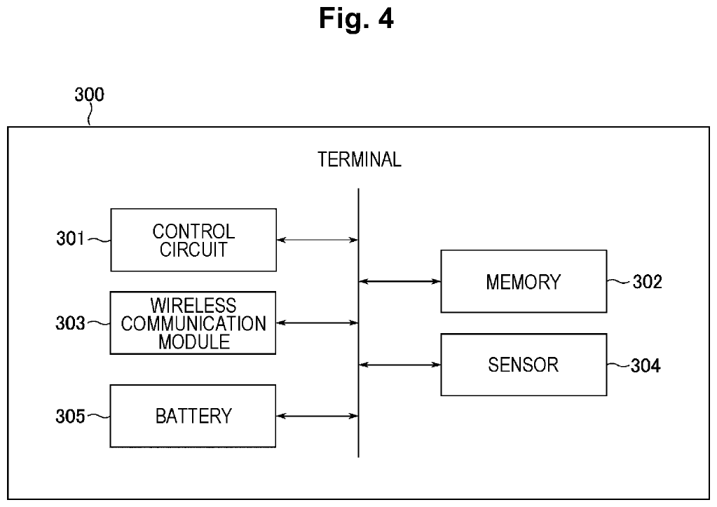

FIG. 4 is a block diagram illustrating an example of a hardware configuration of the terminal according to the embodiment.

As illustrated in FIG. 4, the terminal 300 includes a control circuit 301, a memory 302, a wireless communication module 303, a sensor 304, and a battery 305.

The control circuit 301 is a circuit that has overall control of the components of the terminal 300. The control circuit 301 includes a CPU, a RAM, a ROM, and the like.

The memory 302 is an auxiliary storage device of the terminal 300. The memory 302 includes, for example, an HDD, an SSD, a memory card, and the like. The memory 302 stores control information generated by the wireless communication management apparatus 100 in the wireless communication management operation and sensor information measured by the sensor 304.

The wireless communication module 303 is a circuit used for transmission and reception of data by a wireless signal. The wireless communication module 303 conforms to a protocol stack equivalent to that of the wireless communication module 204. With this configuration, the wireless communication module 303 can be wirelessly connected to the wireless communication module 204.

The sensor 304 is a circuit that measures data monitored by the wireless communication system 2. The sensor information measured by the sensor 304 is aggregated in the data server 500 via the base station and the network NW.

The battery 305 is a capacity for supplying power to the terminal 300. The battery 305 is charged by, for example, a solar power generation module (not illustrated). Note that while FIG. 4 describes a case where the terminal 300 supplies power by charging the battery 305 by solar power generation, the present invention is not limited thereto. For example, the terminal 300 may be stably supplied with power from a power supply.

Next, a functional configuration of a main configuration in the communication system of the embodiment will be described.

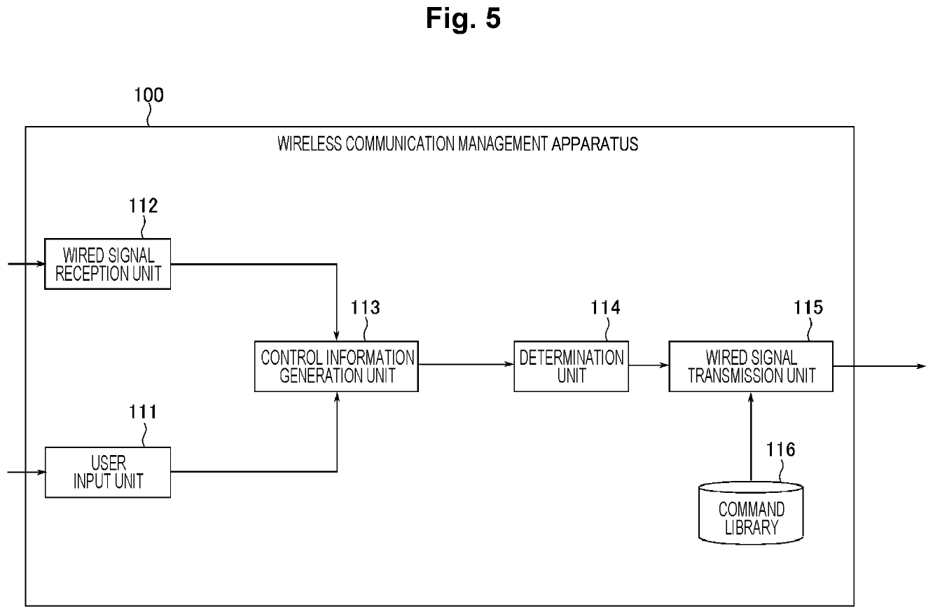

FIG. 5 is a block diagram illustrating an example of a functional configuration of the wireless communication management apparatus according to the embodiment.

The CPU of the control circuit 101 loads the wireless communication management program stored in the memory 102 or the storage medium 107 into the RAM. Then, the CPU of the control circuit 101 controls each of the components 102 to 106 by interpreting and executing the wireless communication management program expanded in the RAM. As a result, as illustrated in FIG. 5, the wireless communication management apparatus 100 functions as a computer including a user input unit 111, a wired signal reception unit 112, a control information generation unit 113, a determination unit 114, a wired signal transmission unit 115, and a command library 116.

The user input unit 111 transmits registration information input by the user to the control information generation unit 113. Registration information includes device information and constraint information.

Device information is information for the wireless communication management apparatus 100 to uniquely identify the base station and the terminal 300. Device information includes, for example, a username, a password, an IP address, a management target flag, and the like for each of the base station and the terminal 300. A username, a password, and an IP address are used for the wireless communication management apparatus 100 to log in to the base station and the terminal 300 by an external access scheme (e.g., SSH). The management target flag is information for identifying whether or not the corresponding base station and terminal 300 are targets of the wireless communication management operation.

Constraint information is information indicating constraint conditions to be complied with by the wireless communication system 2 on the basis of laws such as the Radio law. Constraint information includes, for example, an upper limit value of the total transmission time for each device.

The wired signal reception unit 112 receives wireless environment information of the base station 200 and the terminal 300 from the base station 200. The wired signal reception unit 112 receives external environment information from the external server 400. The wired signal reception unit 112 transmits the received pieces of environment information to the control information generation unit 113.

Wireless environment information is information collected from the base station and the terminal 300 to evaluate the throughput of wireless communication in the wireless communication management operation. Wireless environment information includes, for example, a service set identifier (SSID), a channel, a bandwidth, a frequency, a received signal strength indication (RSSI) value, and the like of a peripheral basic service set (BSS) as information common to the base station and the terminal 300. Furthermore, wireless environment information can include, for example, information indicating the remaining capacity of the battery 305 as information specific to the terminal 300.

External environment information is information collected from the external server 400 to evaluate the throughput of wireless communication. External environment information includes, for example, a predicted value of sunshine hours in an area where the wireless communication system 2 is provided.

The control information generation unit 113 generates control information of the base station and the terminal 300 on the basis of registration information, wireless environment information of the base station and the terminal 300, and external environment information. The control information generation unit 113 may store the received pieces of information in the memory 102 until all the information used for the wireless communication management operation is prepared. The control information generation unit 113 transmits the generated control information to the determination unit 114.

Control information is a parameter used for constructing a wireless communication environment of the base station and the terminal 300. The control information of a certain device is generated on the basis of at least the wireless environment information collected from the certain device. The control information of a certain device can be generated further on the basis of wireless environment information collected from devices other than the certain device. Control information includes connection destination information (SSID), and access parameters, channels, and transmission rates of the base station 200 and the terminal 300. In addition, control information includes information indicating transmission time zones and a transmission frequency (duty ratio) of the base station 200 and the terminal 300.

The determination unit 114 determines various conditions. For example, the determination unit 114 determines whether or not to update the setting of the wireless environment by the generated control information for each of the base station and the terminal 300 for which the control information has been generated. In addition, the determination unit 114 further determines, for each of the base station and the terminal 300 determined to update the setting of the wireless environment, whether or not the update involves a restart. The determination unit 114 transmits a set of control information and a determination result for each of the base station and the terminal 300 to the wired signal transmission unit 115.

The wired signal transmission unit 115 generates various commands for controlling the base station 200 and the terminal 300 on the basis of an instruction from the control circuit 101. The various commands are generated with reference to the command library 116.

In the command library 116, a command group used for the wireless communication management operation is stored in advance. The command library 116 stores, for example, a collection command and an update command. The collection command is a command for collecting wireless environment information from the designated base station or terminal 300 (designated by IP address or the like). The update command is a command for updating the setting of the wireless environment of the designated base station 200 or terminal 300 (designated by IP address or the like) with the control information. Therefore, the update command includes control information for updating the setting of the wireless environment of the designated base station 200 or terminal 300. In addition, the update command may include an instruction to restart the designated base station 200 or terminal 300.

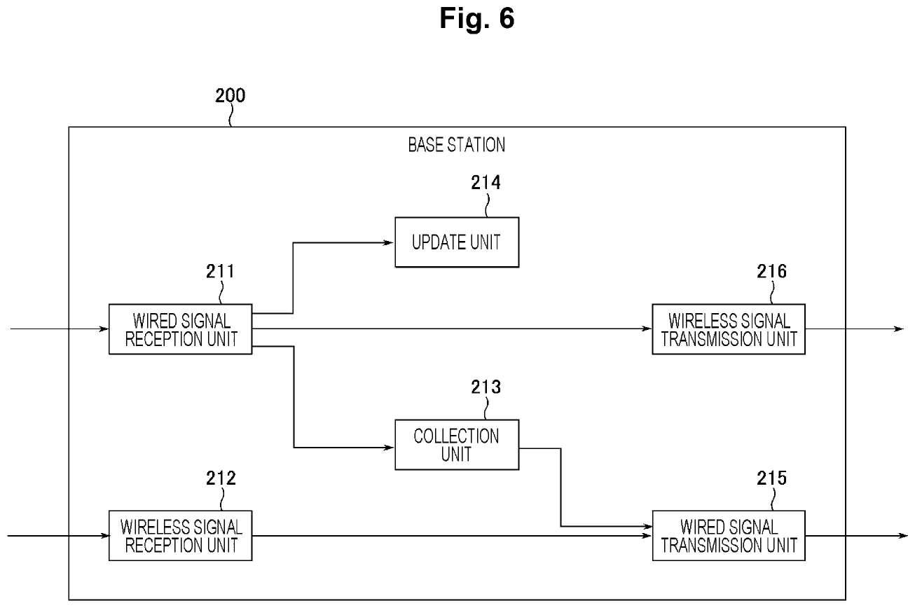

Next, FIG. 6 is a block diagram illustrating an example of a functional configuration of the base station 200 according to the embodiment.

The CPU of the control circuit 201 controls each of the components 202 to 204 on the basis of various commands transmitted from the wireless communication management apparatus 100. As a result, as illustrated in FIG. 6, the base station 200 functions as a computer including a wired signal reception unit 211, a wireless signal reception unit 212, a collection unit 213, an update unit 214, a wired signal transmission unit 215, and a wireless signal transmission unit 216.

The wired signal reception unit 211 receives a collection command and an update command from the wireless communication management apparatus 100. When receiving a collection command (to base station 200) addressed to the base station 200, the wired signal reception unit 211 transmits the collection command to the collection unit 213. When receiving an update command to the base station 200, the wired signal reception unit 211 transmits the update command to the update unit 214. When receiving a collection command and an update command (to terminal 300) addressed to the terminal 300, the wired signal reception unit 211 transmits the collection command and the update command to the wireless signal transmission unit 216. When data is transmitted from the wired signal reception unit 211 to the wireless signal transmission unit 216, the transmission data is converted from the Ethernet frame format to the 802.11 ah frame format.

The wireless signal reception unit 212 receives wireless environment information of the terminal 300 from the terminal 300. The wireless signal reception unit 212 transmits the received wireless environment information of the terminal 300 to the wired signal transmission unit 215. When data is transmitted from the wireless signal reception unit 212 to the wired signal transmission unit 215, the transmission data is converted from the 802.11 ah frame format to the Ethernet frame format.

The collection unit 213 collects wireless environment information of the base station 200 on the basis of the received collection command. The collection unit 213 transmits the collected wireless environment information of the base station 200 to the wired signal transmission unit 215.

The update unit 214 updates the setting of the wireless environment of the base station 200 with control information in the update command on the basis of the received update command. When the update command includes a restart instruction, the update unit 214 restarts the base station 200.

The wired signal transmission unit 215 transmits the received wireless environment information of the base station 200 to the wireless communication management apparatus 100. The wired signal transmission unit 215 transfers the received wireless environment information of the terminal 300 to the wireless communication management apparatus 100.

The wireless signal transmission unit 216 transfers the received collection command and update command of the terminal 300 to the terminal 300.

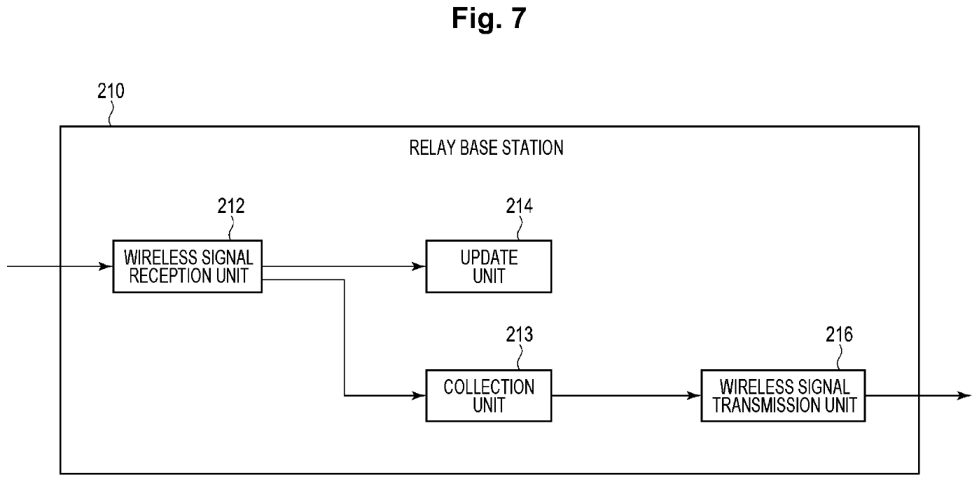

Next, FIG. 7 is a block diagram illustrating an example of a functional configuration of the relay base station 210 according to the embodiment.

The CPU of the control circuit 201 controls each of the components 202 and 204 on the basis of various commands transmitted from the wireless communication management apparatus 100. As a result, as illustrated in FIG. 7, the relay base station 210 functions as a computer including the wireless signal reception unit 212, the collection unit 213, the update unit 214, and the wireless signal transmission unit 216.

Note that since the function of the relay base station 210 is transmission and reception of various information and various commands by wireless connection, the wireless signal reception unit 212 wirelessly receives update commands and collection commands to the relay base station 210, and, regarding another relay base station 210 or the terminal 300 connected to the relay base station 210, the wireless signal transmission unit 216 wirelessly transmits update commands and collection commands to the other relay base station 210 or the terminal 300.

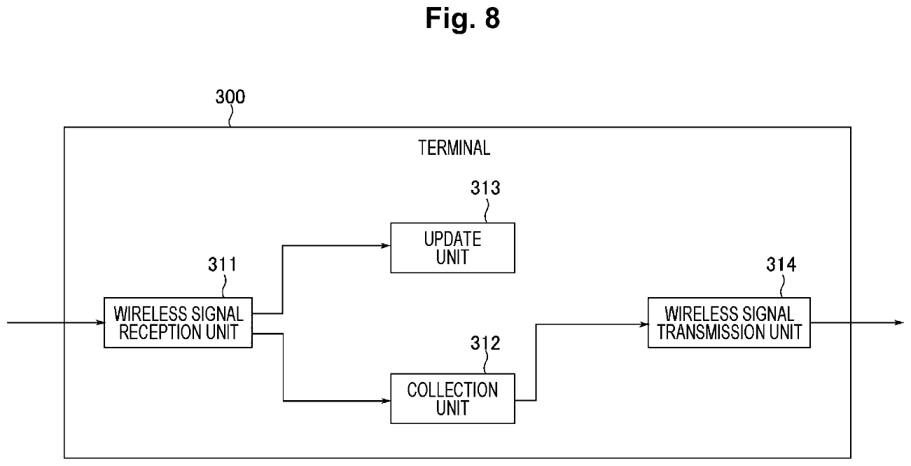

FIG. 8 is a block diagram illustrating an example of a functional configuration of the terminal according to the embodiment.

The CPU of the control circuit 301 controls each of the components 302 and 303 on the basis of various commands transmitted from the wireless communication management apparatus 100. As a result, as illustrated in FIG. 8, the terminal 300 functions as a computer including a wireless signal reception unit 311, a collection unit 312, an update unit 313, and a wireless signal transmission unit 314.

The wireless signal reception unit 311 receives a collection command and an update command from the base station. The wireless signal reception unit 311 transmits the collection command to the collection unit 312. The wireless signal reception unit 311 transmits the update command to the update unit 313.

The collection unit 312 collects wireless environment information of the terminal 300 on the basis of the received collection command. The collection unit 312 transmits the collected wireless environment information of the terminal 300 to the wireless signal transmission unit 314.

The update unit 313 updates the setting of the wireless environment of the terminal 300 with control information in the update command on the basis of the received update command. When the update command includes a restart instruction, the update unit 313 restarts the terminal 300.

The wireless signal transmission unit 314 transmits the collected wireless environment information of the terminal 300 to the base station.

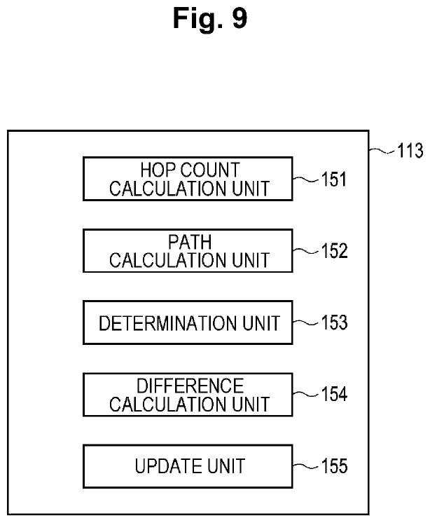

Next, details of the control information generation unit 113 in the wireless communication management apparatus 100 will be described with reference to FIG. 9.

The control information generation unit 113 illustrated in FIG. 9 includes a hop count calculation unit 151, a path calculation unit 152, a determination unit 153, a difference calculation unit 154, and an update unit 155.

The hop count calculation unit 151 calculates the minimum hop count from a root base station to the connectable relay base station 210, and the minimum hop count from the root base station to the connectable terminal 300 or to the connectable terminal 300 via the relay base station 210. A root base station is a base station serving as a starting point of multi-hop communication in which a plurality of devices communicate signals in a bucket brigade style from the root base station to one or more relay base stations 210 and a plurality of terminals 300.

On the basis of wireless environment information collected from one or more relay base stations 210 and a plurality of terminals 300 configured to wirelessly communicate with the root base station, the path calculation unit 152 calculates one or more path candidates which are connectable paths that can be taken as a network configuration by multi-hop communication and in which the traffic amount of each relay base station 210 included in the connectable paths is less than a threshold.

The determination unit 153 determines one of one or more path candidates as the optimal path. Note that the determination unit 153 may determine, as the optimal path, a path candidate having the fairest duty ratio of the transmission time of the relay base station 210 and the terminal 300.

The difference calculation unit 154 calculates, for each terminal, the difference between a received signal strength value with a root base station or a relay base station to be a connection destination in the optimal path and a maximum received signal strength value with a root base station or a relay base station whose presence is recognizable by the terminal.

The update unit 155 updates the connection destinations of the terminal 300 and the relay base station 210 on the basis of the optimal path. In addition, the update unit 155 updates the transmission power of the relay base station 210 by using the sum of the differences of the terminals 300 connectable to the relay base station 210.

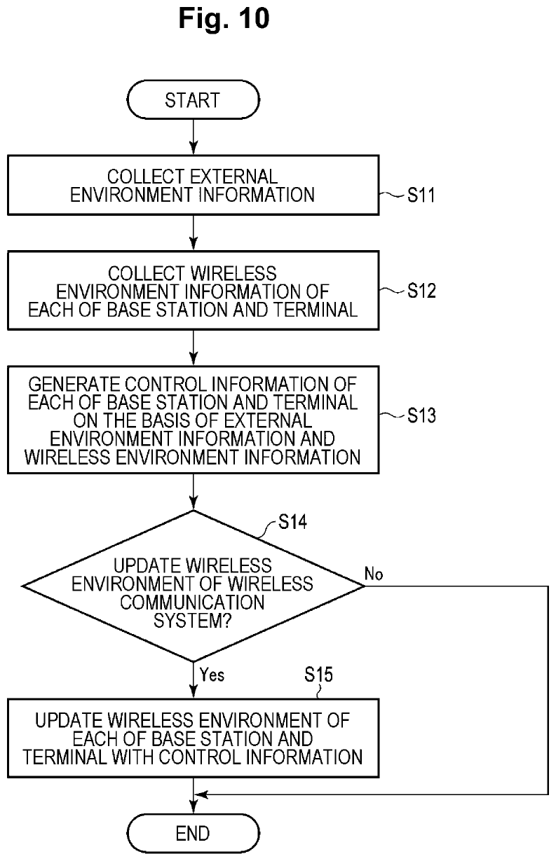

Next, an example of a wireless communication management operation in the wireless communication management apparatus according to the embodiment will be described with reference to a flowchart of FIG. 10. In FIG. 10, it is assumed that registration information is stored in the memory 102 in advance by user input.

In step S11, the wireless communication management apparatus 100 collects external environment information from the external server 400.

In step S12, the wireless communication management apparatus 100 collects external environment information from each of the base station and the terminal 300. The processing of step S12 may be performed before the processing of step S11, or may be performed in parallel with the processing of step S11.

In step S13, the wireless communication management apparatus 100 generates control information of each of the base station and the terminal 300 on the basis of the collected external environment information, wireless environment information, and registration information.

In step S14, the wireless communication management apparatus 100 determines whether or not to update the setting of the wireless environment of the wireless communication system 2. If it is determined that the setting of the wireless environment of the wireless communication system 2 is to be updated, the processing proceeds to step S15, and if it is determined that the setting of the wireless environment is not to be updated, the processing ends.

In step S15, the wireless communication management apparatus 100 updates the setting of the wireless environment of each of the base station and the terminal 300 with the control information.

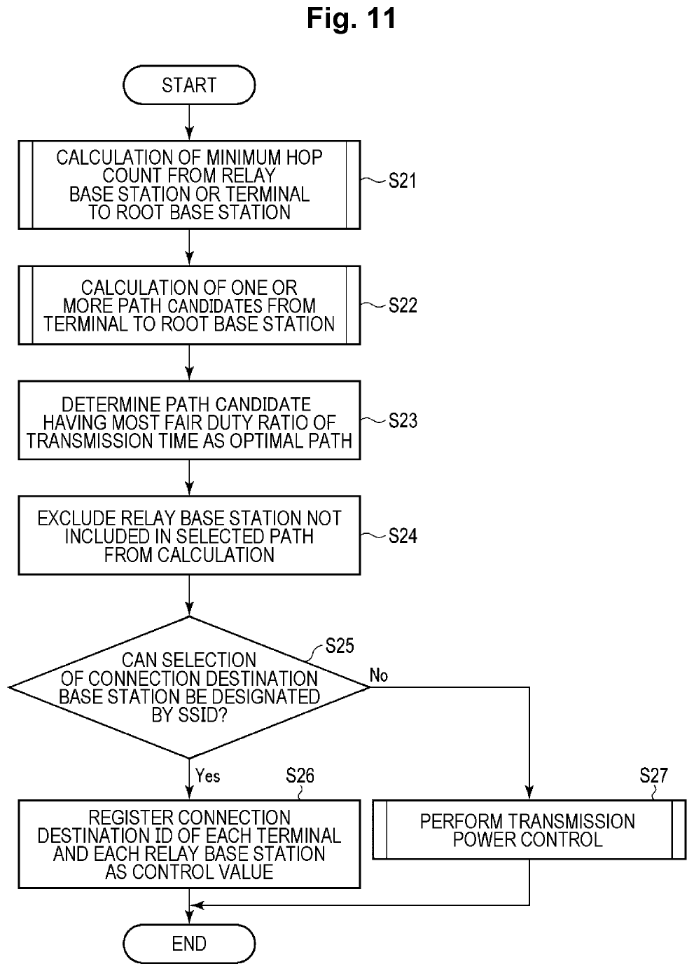

Next, optimal path determination processing of the wireless communication management apparatus according to the present embodiment will be described with reference to a flowchart of FIG. 11. The optimal path determination processing illustrated in FIG. 11 may be performed when it is determined in step S14 of FIG. 10 that the setting of the wireless environment is to be updated, or may be performed as an initial setting at the time of laying the wireless communication system 2.

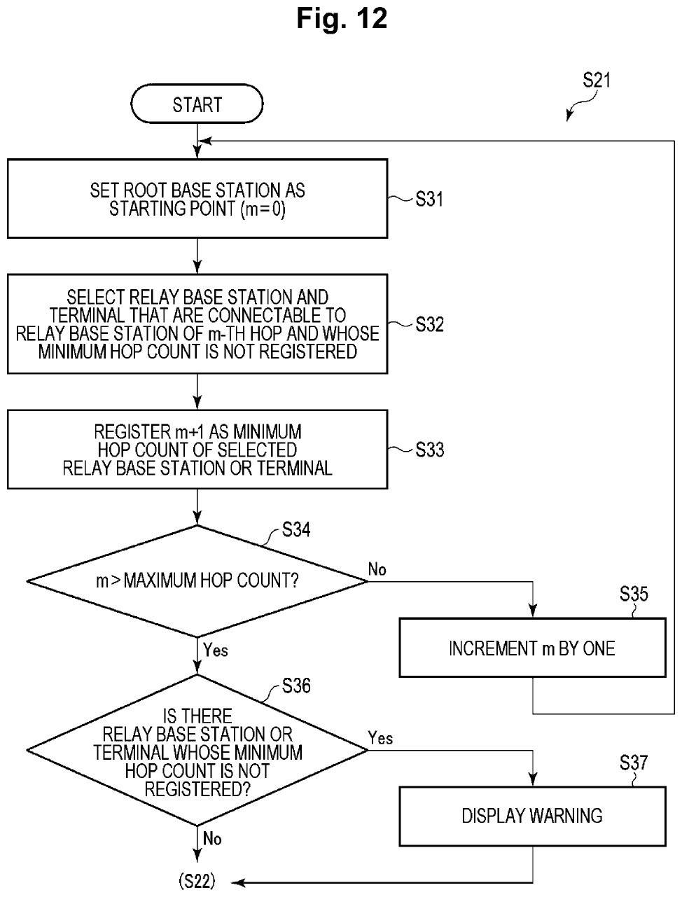

In step S21, the hop count calculation unit 151 calculates the minimum hop count from the relay base station 210 or the terminal 300 to the root base station for each of the relay base station 210 and the terminal 300. The processing of the hop count calculation unit 151 will be described later with reference to FIG. 12.

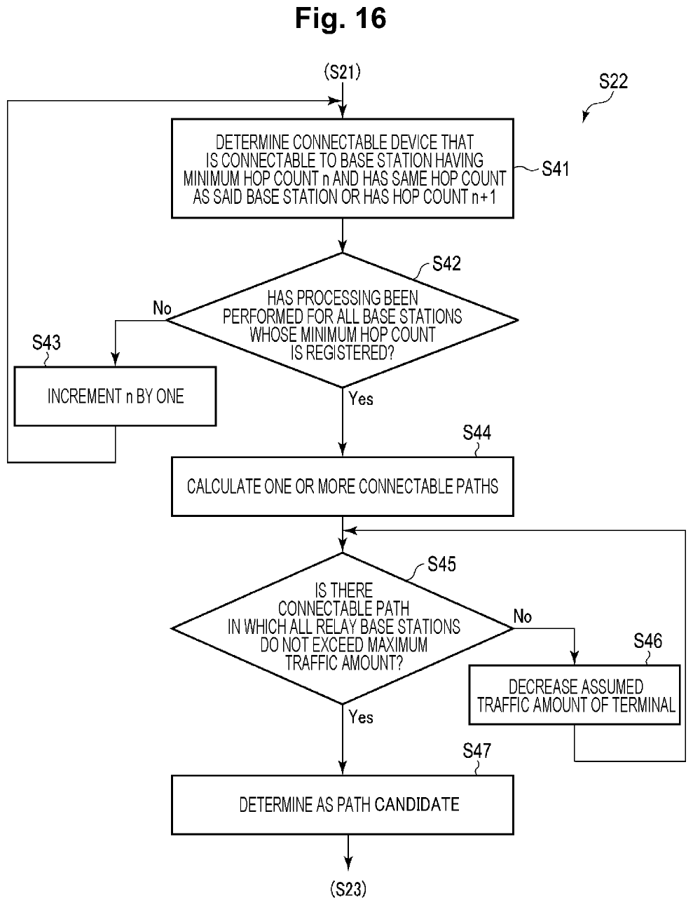

In step S22, the path calculation unit 152 calculates one or more path candidates that can be taken as a network configuration in multi-hop communication from the terminal 300 to the root base station. The processing of the path calculation unit 152 will be described later with reference to FIG. 16.

In step S23, the determination unit 153 determines a path candidate having the fairest duty ratio of the transmission time as the optimal path. Note that the optimal path is not limited to being determined from the viewpoint of fairness of the duty ratio of the transmission time, and the optimal path may be set from the viewpoint of fairness of power consumption on the basis of power consumption of the device and the remaining battery level of the device.

In step S24, in preparation for minimizing the transmission power, the determination unit 153 excludes the relay base station 210 not included in the optimal path from the calculation of the transmission power. This is because the transmission power only needs to be controlled for the connectable relay base station 210.

In step S25, the determination unit 114 determines whether or not the base station to be the connection destination of the terminal can be designated by a connection destination ID. A connection destination ID is, for example, an SSID. If the connection destination can be designated by a connection destination ID, the processing proceeds to step S26. On the other hand, if the connection destination cannot be designated by a connection destination ID, such as a case where the same SSID is assigned to the entire network, it is necessary to distinguish the connection destination by the RSSI value or the like, and thus the processing proceeds to step S27.

In step S26, the update unit 155 registers the connection destination IDs of the terminals 300 and the relay base stations 210 as control values.

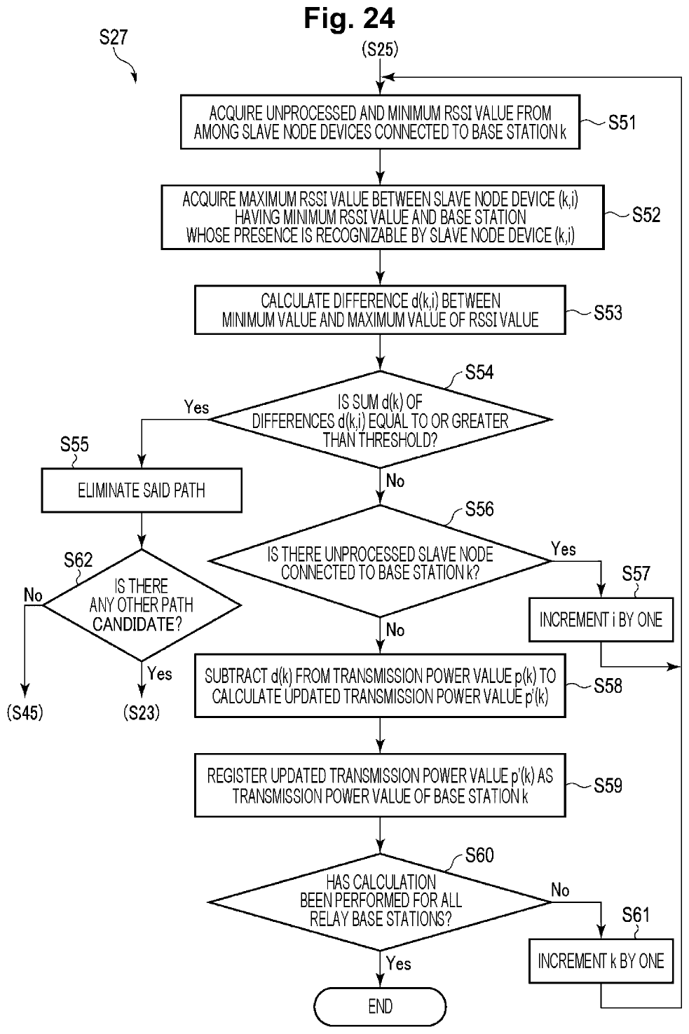

In step S27, for example, the difference calculation unit 154 and the update unit 155 perform transmission power control. The processing of the difference calculation unit 154 and the update unit 155 will be described later with reference to FIG. 24.

Note that while the path candidate having the fairest duty ratio of the transmission time is determined as the optimal path in step S23, in a case where the terminal 300 is connected to the power supply and can receive stable power supply, for example, the remaining battery level of each terminal 300 need not be considered. Therefore, the determination unit 153 may determine the optimal path without considering the duty ratio of the transmission time. For example, the determination unit 153 may determine one path candidate selected by the user from among the path candidates as the optimal path, or may determine one path candidate randomly selected from among the path candidates as the optimal path. As a result, it is possible to determine the optimal path while complying with the constraint of the transmission time set by laws and regulations.

Next, the calculation processing of the minimum hop count according to step S21 will be described with reference to a flowchart of FIG. 12.

In step S31, the hop count calculation unit 151 sets a root base station as a starting point. Here, an initial value of a hop count m (m is integer of zero or more) is set to zero. That is, the root base station is set to the zero hop.

In step S32, the hop count calculation unit 151 selects the relay base station 210 and the terminal 300 that are connectable to the base station of the m-th hop and whose minimum hop count is not registered. Here, “connectable” indicates a state in which it can be determined that direct communication with the base station of the m-th hop is possible, and, for example, it may be determined that a device is connectable when the RSSI value is equal to or larger than a threshold. Whether or not the minimum hop count is registered may be determined, for example, by storing a management table in which the minimum hop count obtained in the subsequent processing is registered in the data server 500 and the hop count calculation unit 151 referring to the management table. Note that in addition to the RSSI value, whether or not other indices such as a signal to noise ratio (SNR) value or a signal to interference plus noise ratio (SINR) is equal to or larger than a threshold may be used for determining whether or not a device is connectable.

In step S33, the hop count calculation unit 151 registers “m+1” as the minimum hop count of the relay base station 210 and the terminal 300 selected in step S32 in the management table. For example, the zero-hop base station 200, that is, the minimum hop count of the relay base station 210 or the terminal 300 that can reach the root base station is registered as “1”.

In step S34, the determination unit 114 determines whether or not the hop count m is larger than the maximum hop count. If m is larger than the maximum hop count, the processing proceeds to step S36. If m is equal to or smaller than the maximum hop count, the processing proceeds to step S35. It is assumed that the maximum hop count is set in advance by user input or the like, on the basis of the numbers and arrangement relationships of the relay base station 210 and the terminals 300, for example.

In step S35, the hop count calculation unit 151 increments the hop count m by one.

In step S36, the determination unit 114 determines whether or not there is a relay base station 210 or a terminal 300 whose minimum hop count is not registered even when the hop count m exceeds the maximum hop count. If there is a relay base station 210 or a terminal 300 whose minimum hop count is not registered, the processing proceeds to step S37. If there is no relay base station 210 or terminal 300 whose minimum hop count is not registered, that is, if the minimum hop count is registered for all the relay base stations 210 and terminals 300, the processing proceeds to step S22.

In step S37, for example, the wireless communication management apparatus 100 notifies the user of a warning message. This is because if there is a terminal 300 that cannot be connected even with the assumed maximum hop count, it is considered that there is a problem in the arrangement of the relay base station 210 and the terminal 300 or a problem in the setting of the communication parameter. Therefore, by notifying the user of the warning message, it is possible to notify that there is a problem. Note that the wireless communication management apparatus 100 may be configured to continue the communication processing even if there is a relay base station 210 or a terminal 300 that cannot be connected. For example, a confirmation message such as “Would you like to continue processing in this state?” may be displayed to the user so that the user can make a determination. When receiving an instruction from the user to perform the processing even if there is a relay base station 210 or a terminal 300 that cannot be connected, the wireless communication management apparatus 100 may exclude the relay base station 210 or the terminal 300 that cannot be connected and perform the optimal path calculation processing.

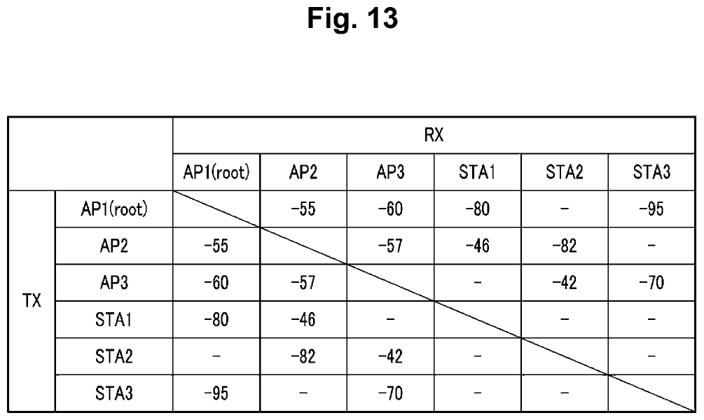

Next, as a specific example, an example of a management table of RSSI values used to set the minimum hop count will be described with reference to FIG. 13.

The management table illustrated in FIG. 13 indicates RSSI values in a combination of a device (base station or terminal 300) on the transmission side (connection source) and a device (base station or terminal 300) on the reception side (connection destination). Here, it is assumed that the base station and the terminal 300 belonging to the assumed network configuration include a root base station AP1 as a starting point, relay base stations AP2 and AP3, and terminals STA1 to STA3. Hereinafter, specific examples will be described by using this network configuration as an example. Note that in the example of FIG. 13, since a value obtained by averaging the RSSI values on the transmission side and the RSSI values on the reception side is used, the RSSI values are the same even if the device on the transmission side and the device on the reception side are exchanged. However, management tables may be used in which the RSSI values on the transmission side and the RSSI values on the reception side are measured independently of each other and are different when the device on the transmission side and the device on the reception side are exchanged.

Referring to the management table illustrated in FIG. 13, it can be seen that, in the root base station AP1, the RSSI value with the relay base station AP2 is “−55 [dBm]” (hereinafter, unit of RSSI value is omitted), which is the highest, and the RSSI value with the terminal STA3 is“−95”, which is the lowest.

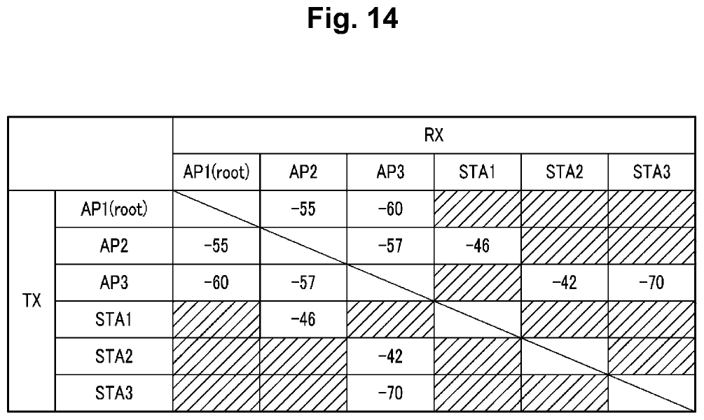

Next, an example of a result of determining connectivity with reference to the management table illustrated in FIG. 13 by the hop count calculation unit 151 will be described with reference to FIG. 14.

FIG. 14 is the same management table as FIG. 13. Here, the threshold of the RSSI value for determining that a device is connectable in FIG. 13 is “−75”. When the cell having the RSSI value less than the threshold is filled, the management table in FIG. 14 is obtained. For example, in the relay base station AP3, the RSSI value with the root base station AP1 is “−60”, the RSSI value with the relay base station AP2 is “−73”, and both the RSSI values are higher than the threshold “−75”. Therefore, it can be seen that the relay base station AP3 is connectable to both the root base station AP1 and the relay base station AP2.

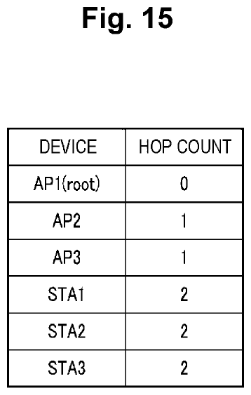

Next, an example of the management table of the minimum hop count is illustrated in FIG. 15.

In the management table illustrated in FIG. 15, the type of the device and the minimum hop count are stored in association with each other. Referring to the determination result of connectivity of FIG. 14, for example, since the relay base station AP2 and the relay base station AP3 are directly connectable to the root base station AP1, the minimum hop count of each of the relay base station AP2 and the relay base station AP3 is calculated to be “1”. Similarly, since the terminal STA1 is connectable to the relay base station AP2, and the terminal STA2 and the terminal STA3 are connectable to the relay base station AP3, the minimum hop count of each of the terminal STA1 to the terminal STA3 is calculated as “2”. Note that while the relay base station AP3 is also connectable to the relay base station AP2, when the relay base station AP3 is connected to the relay base station AP2, the hop count is “2”, and thus, the hop count “1” when the relay base station AP3 is directly connected to the root base station AP1 is calculated as the minimum hop count.

Next, path candidate calculation processing according to step S22 will be described with reference to a flowchart of FIG. 16.

In step S41, on the basis of the minimum hop count n (n is integer of zero or more), the path calculation unit 152 determines the relay base station 210 or the terminal 300 that is connectable to the base station and whose minimum hop count is the same as the base station or is “minimum hop count +1” as a connectable device. Here, the initial value of n is set to zero. A determination similar to that in step S32 may be used as to whether or not the device is connectable. In step S41, the initial processing is processing of determining the relay base station 210 and the terminal 300 connectable to the base station with the minimum hop count of zero, that is, the root base station, as connectable devices, and the subsequent processing determines devices connectable to the relay base station 210. Note that since a device belonging to the terminal 300 is not assumed, the connectable device is determined for the base station.

Note that as the connectable device, all the relay base stations 210 and the terminals 300 that satisfy the condition in step S41 may be determined as connectable devices, or a predetermined number of the relay base stations 210 and the terminals 300 in descending order of the RSSI value may be determined as connectable devices.

In step S42, the determination unit 114 determines whether or not processing has been performed for all the base stations whose minimum hop count is registered. If processing has been performed for all the base stations, the processing proceeds to step S44. If processing has not been performed for all the base stations, that is, there is an unprocessed base station, the processing proceeds to step S43.

In step S43, n is incremented by one, and the processing returns to step S41 to repeat similar processing. By the processing from step S41 to step S43, which device is connectable to the base station to be processed is sequentially checked from the root base station so as to widen the area.

In step S44, the path calculation unit 152 calculates one or more connectable paths on the basis of a combination that the connectable device can take as a path to the root base station. As a method of calculating the connectable path, for example, the relay base station 210, which is a device connectable to the root base station, generates a possibility that can be taken as a path to the root base station. Subsequently, the terminal 300, which is a device connectable to the relay base station 210, generates a possibility that can be taken as a path to the relay base station 210, thereby generating one or more connectable paths. Note that a path exceeding the maximum hop count is excluded from the connectable path because there is a possibility that a redundant path is traced and there is a possibility that the path is not appropriate as a network configuration due to constraints such as transmission times of the relay base station 210 and the terminal 300.

In step S45, the determination unit 114 determines whether or not there is a connectable path in which all the relay base stations 210 do not exceed the maximum traffic amount serving as the upper limit. Specifically, when the sum of the assumed traffic amounts of one or more terminals 300 directly connected to the relay base station 210 or indirectly connected to the relay base station 210 via another relay base station 210 is larger than the maximum traffic amount transmittable by the relay base station 210, it may be determined that the traffic amount exceeds the maximum traffic amount in the relay base station 210. Note that the assumed traffic amount of the terminal 300 is, for example, a traffic amount set by an application or a traffic amount set as a limit value defined by the Radio law or the like. Hereinafter, a traffic amount set as a limit value is assumed as the assumed traffic amount.

If there is a connectable path in which all the relay base stations 210 do not exceed the maximum traffic amount, the processing proceeds to step S47. On the other hand, if there is no connectable path in which all the relay base stations do not exceed the maximum traffic amount, that is, if at least one relay base station 210 exceeds the maximum traffic amount in each of one or more connectable paths, the processing proceeds to step S46.

In step S46, since the relay base station 210 exceeding the maximum traffic amount is generated in all the connectable paths, the path calculation unit 152 decreases the assumed traffic amount of the terminal 300. For example, the assumed traffic amount may be decreased by a predetermined ratio or a predetermined value in all the terminals 300 by uniformly decreasing the assumed traffic amount of the terminal 300 by 20%, or the decrease rate of the assumed traffic amount may be individually changed by decreasing the assumed traffic amount for a terminal having the largest assumed traffic amount among the terminals 300 connected to the relay base station 210.

Thereafter, the processing returns to step S45, and the processing of steps S45 and S46 are repeated until there is at least one connectable path in which all the relay base stations 210 do not exceed the maximum traffic amount.

In step S47, the path calculation unit 152 determines a connectable path in which all the relay base stations 210 do not exceed the maximum traffic amount as a path candidate. Thereafter, the processing proceeds to step S23.

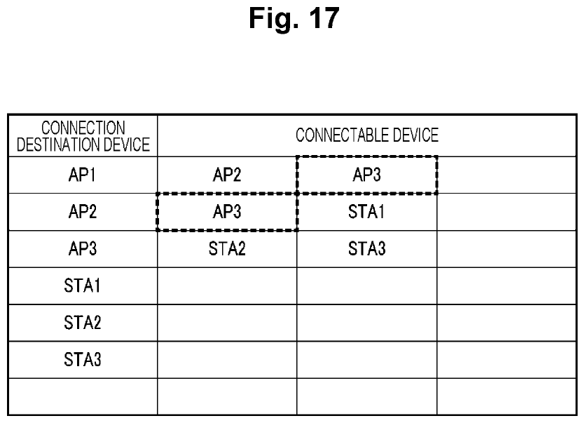

Next, as a specific example, an example of a connectable device as a processing result of step S41 is illustrated in FIG. 17.

FIG. 17 is a management table illustrating a correspondence relationship between a connection destination device and a connectable device related to the connection destination device. For example, referring to FIGS. 14 and 15, the root base station AP1 has a minimum hop count of zero, and there is no base station having the same minimum hop count. Next, since the relay base station AP2 and the relay base station AP3 having the minimum hop count n+1, that is, the minimum hop count “1” have RSSI values equal to or larger than the threshold with respect to the root base station AP1, the relay base station AP2 and the relay base station AP3 are determined as connectable devices with respect to the root base station AP1.

Similarly, regarding the relay base station AP2, since the relay base station AP3 having the same minimum hop count “1” has an RSSI value equal to or larger than the threshold with respect to the relay base station AP2, the relay base station AP3 is determined as the connectable device. Next, the terminals STA1 to STA3 have the minimum hop count “n+1”, that is, the minimum hop count “2”, and among them, the terminal STA1 having the RSSI value equal to or larger than the threshold with respect to the relay base station AP2 is determined as the connectable device.

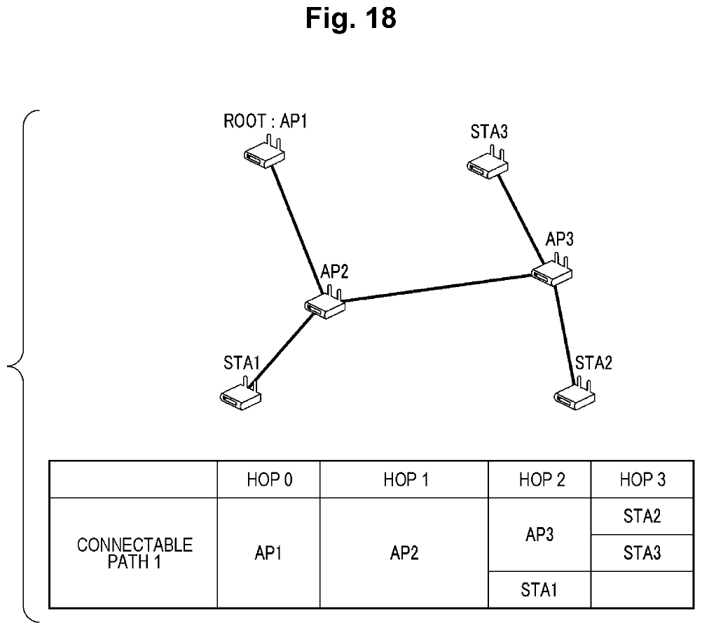

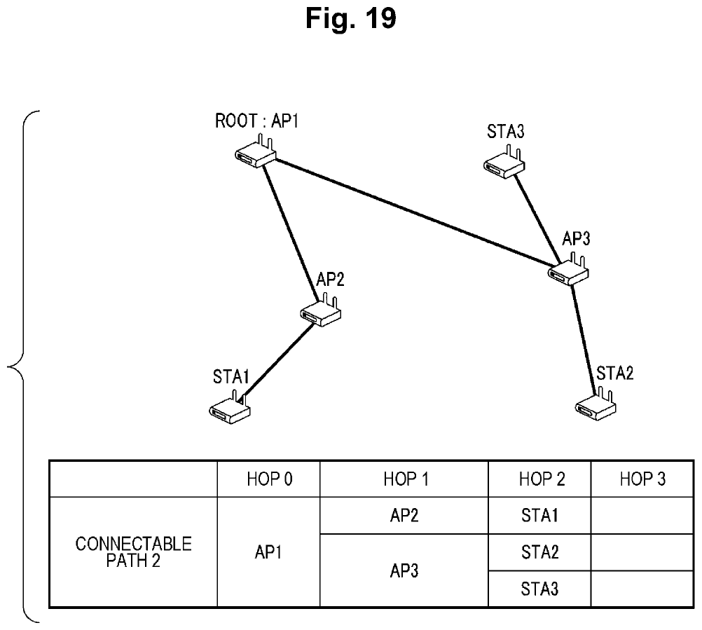

Subsequently, an example of one or more connectable paths as a processing result of step S44 is illustrated in FIGS. 18 and 19.

The upper diagrams of FIGS. 18 and 19 are conceptual diagrams illustrating assumed connectable paths in a network configuration tracing the root base station AP1 to the terminals STA1 to STA3, and the lower diagrams of FIGS. 18 and 19 are management tables expressing the connectable paths from the root base station AP1 to the terminals STA1 to STA3 in the hop count.

Specifically, referring to FIG. 17, the relay base station AP3 surrounded by a broken line in FIG. 17 is connectable to the root base station AP1 and is also connectable to the relay base station AP2. Therefore, a connectable path in a case where the relay base station AP3 is connected (belongs) to the relay base station AP2 and only the relay base station AP2 is connected to the root base station AP1 as illustrated in FIG. 18 and a connectable path in a case where the relay base stations AP2 and AP3 are connected (belong) to the root base station AP1 as illustrated in FIG. 19 are determined as connectable paths that can be taken. Hereinafter, for convenience of description, the connectable path in FIG. 18 is referred to as a connectable path 1, and the connectable path in FIG. 19 is referred to as a connectable path 2.

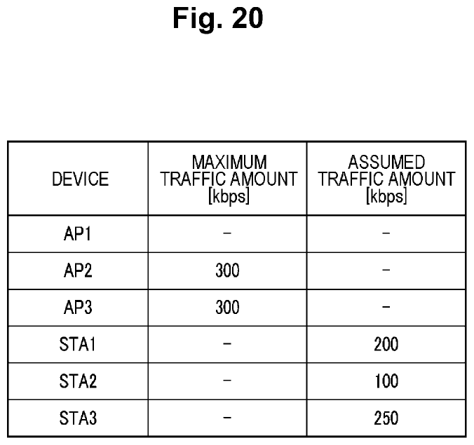

Subsequently, specific examples of processing in steps S45 and S46 will be described with reference to FIGS. 20 to 23.

FIG. 20 is a management table including the maximum traffic amount serving as the upper limit allowed by the relay base station and the assumed traffic amount assumed by the terminal, and, for example, it is assumed that values are set in advance by user input.

Specifically, for example, in the relay base stations AP2 and AP3, the maximum traffic amount is 300 [kbps], the assumed traffic amount of the terminal STA1 is 200 [kbps], and the assumed traffic amount of the terminal STA2 is smaller than that of the terminal STA1 and is 100 [kbps].

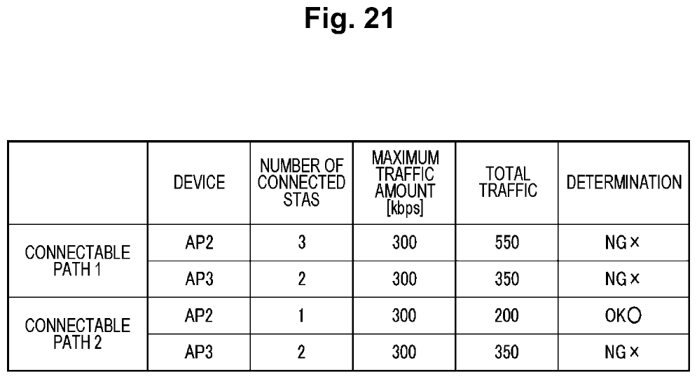

FIG. 21 is a management table illustrating determination results of the maximum traffic amount and the assumed traffic amount of the relay base station included in the connectable paths. In the management table, “device” indicates the relay base station included in the connectable path. “Number of connected STAs” is the sum of a terminal directly connected to a relay base station and a terminal indirectly connected via a relay base station. The maximum traffic amount is the maximum traffic amount illustrated in FIG. 20. “Total traffic” is the total of the assumed traffic amounts of the terminals for the number of connected STAs connected to the relay base station. “Determination” is a result of determining whether or not the total traffic exceeds the maximum traffic amount.

As illustrated in FIG. 21, in the connectable path 1, since the terminals connected to the relay base station AP2 are the terminals STA1 to STA3, the total traffic is “200+100+250=550”. Therefore, since the total traffic, which is the assumed traffic amount, exceeds the maximum traffic amount “300” of the relay base station AP2, the determination result is “NG”. A connectable path including at least one relay base station that is “NG” is not treated as a path candidate.

Similar processing is performed for the connectable path 2, and although the total traffic does not exceed the maximum traffic amount for the relay base station AP2, the total traffic exceeds the maximum traffic amount for the relay base station AP3, and thus the connectable path 2 is not treated as a path candidate either.

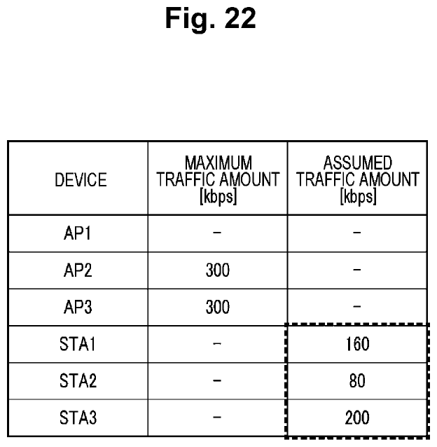

Subsequently, an example of a management table including the maximum traffic amount and the assumed traffic amount when the assumed traffic amount is decreased is illustrated in FIG. 22.

As illustrated in FIG. 22, by the processing of step S46, the path calculation unit 152 decreases the assumed traffic amount when there is no path candidate. Here, an example in which the assumed traffic amounts of the terminals STA1 to STA3 are decreased by 20% is illustrated.

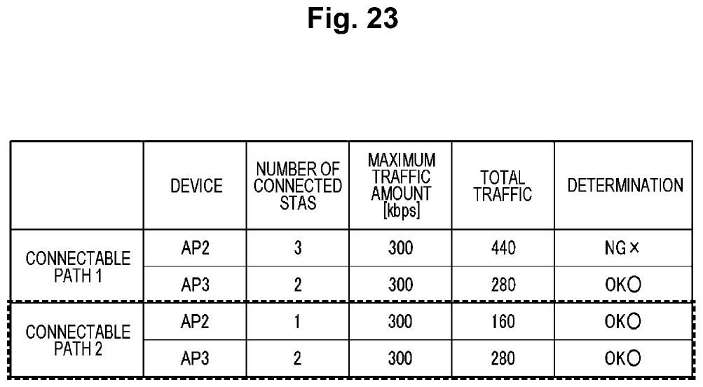

Subsequently, FIG. 23 illustrates a management table indicating a determination result of the maximum traffic amount and the assumed traffic amount when the processing of step S45 is performed again.

As illustrated in FIG. 23, although the connectable path 1 is not treated as a path candidate as in the case of FIG. 21, the connectable path 2 is determined as a path candidate because both the relay base station AP2 and the relay base station AP3 have the total assumed traffic amount less than the maximum traffic amount.

Next, details of the optimal path determination processing in step S23 will be described.

The determination unit 153 calculates the SINR value of each device from the bandwidth information collected from each device and the RSSI value illustrated in FIG. 14. The determination unit 153 determines a modulation coding scheme (MCS) index of each device by using the calculated SINR value and the MTU size collected from each device. The determination unit 153 calculates the frame time length of each device by using the determined MCS index, MTU size, and aggregation number.

Thereafter, the determination unit 153 calculates a transmission time required for each of the terminals from terminal STA1 to STA3 to the root base station by using the calculated frame time length. Here, the frame time lengths of the relay base station and the root base station existing in the route traced by each terminal to the root base station are summed. For example, when the path candidate illustrated in FIG. 18 is selected as the path candidate, the terminal STA1 is connected to the relay base station AP2, and the relay base station AP2 is connected to the root base station AP1. Therefore, the sum of the frame time lengths of the relay base station AP2 and the root base station AP1 is set as the transmission time of the terminal STA1. Similarly, since the terminal STA2 is connected to the relay base station AP3, the relay base station AP3 is connected to the relay base station AP2, and the relay base station AP2 is connected to the root base station AP1, the sum of the frame time lengths of the relay base station AP3, the relay base station AP2, and the root base station AP1 is set as the transmission time of the terminal STA2. The determination unit 153 calculates the standard deviation of the calculated transmission times of the terminals.

When there is a plurality of path candidates, the determination unit 153 calculates the standard deviation of the transmission times for each path candidate as described above. The determination unit 153 determines a path candidate having the smallest standard deviation of the transmission times of the path candidates as the optimal path. That is, when the standard deviation is small, the deviation of the duty ratio of the transmission time in each terminal is small, and a uniform transmission frequency and transmission time are allocated to each terminal. That is, it can be said that the network configuration is fair from the viewpoint of power consumption of the terminals. Note that the calculation method is not limited to the standard deviation, and any calculation method may be used as long as it is an index capable of calculating the deviation of the duty ratio of the transmission time, such as other general statistical processing.

Next, details of the transmission power control in step S27 will be described with reference to a flowchart of FIG. 24. Here, a logic is employed in which the terminal 300 automatically determines the connection destination on the basis of the RSSI value on the assumption that the device to be connected cannot be designated by the SSID, such as a case where the root base station and the relay base station 210 have the same SSID. Therefore, the transmission power is controlled on the side of the relay base station 210 to maintain the optimal path. Note that k is an integer of zero or more, q is the total number of relay base stations 210 included in the optimal path, and r is the total number of terminals 300 included in the optimal path. In addition, the root base station is set as “base station k=0”, and the relay base station 210 is numbered as “base station k (1≤k≤q)” so as to be uniquely identified.

In step S51, the difference calculation unit 154 selects an unprocessed slave node device (k, i) having a minimum RSSI value from among the slave node devices (k, i) connected to the base station k, and acquires the minimum RSSI value. A slave node device indicates the relay base station 210 or the terminal 300 that exists in a path direction opposite to the root base station with respect to the device of interest, that is, in a direction toward the terminal and is directly or indirectly connected to the device of interest. The slave node device (k, i) is also numbered as (1≤i≤r) such that the slave node device i connected to the base station k is uniquely identified.

In step S52, the difference calculation unit 154 acquires the maximum RSSI value between the slave node device (k, i) having the minimum RSSI value and the base station whose presence is recognizable by the slave node device (k, i). “Presence is recognizable” indicates a device determined to be connectable by threshold determination and a connection destination device determined not to be connectable by threshold determination and with which an RSSI value less than the threshold is acquired.

In step S53, the difference calculation unit 154 calculates a difference d(k, i) between the maximum RSSI value acquired in step S52 and the minimum RSSI value acquired in step S51.

In step S54, the determination unit 114 determines whether or not the sum d (k) of the differences d(k, i) calculated for each slave node device (k, i) is equal to or larger than a threshold. If d(k) is equal to or larger than the threshold, the processing proceeds to step S55, and if d (k) is less than the threshold, the processing proceeds to step S56.

In step S55, if the difference calculation unit 154 controls the transmission power in a case where d(k) is equal to or larger than the threshold, there is a possibility that the current optimal path cannot be maintained when the transmission power from the base station is reduced. Hence, the optimal path is deleted.

In step S56, the determination unit 114 determines whether or not there is an unprocessed slave node device (k, i) connected to the base station k. If there is an unprocessed slave node device (k, i), the processing proceeds to step S57, and if there is no unprocessed slave node device (k, i), the processing proceeds to step S58.

In step S57, the difference calculation unit 154 increments i by one and performs the processing from step S51 to step S56 for the remaining slave node devices connected to the base station k.

In step S58, the update unit 155 subtracts d (k) from a default transmission power value p(k) for the base station k to calculate an updated transmission power value p′ (k).

In step S59, the update unit 155 updates the calculated updated transmission power value p′ (k) as a new transmission power value.

In step S60, the determination unit 114 determines whether or not the updated transmission power values p′ (k) have been calculated for all the base stations on the optimal path. If the updated transmission power values p′ (k) have been calculated for all the base stations, the processing ends, and if the updated transmission power values p′ (k) have not been calculated for all the base stations, the processing proceeds to step S61.

In step S61, the difference calculation unit 154 increments k by one and performs the processing from step S51 to step S56 for the remaining base stations.

In step S62, the determination unit 114 determines whether or not there is another path candidate. If there is another path candidate, the processing returns to step S23, and similar processing is repeated to determine the optimal path from the other path candidates. On the other hand, if there is no other path candidate, the processing returns to step S45, and processing such as whether the constraint of the traffic amount is satisfied for the other connectable paths is performed.

Here, a specific example of the transmission power control illustrated in FIG. 24 will be described with reference to FIGS. 13 and 19. Note that it is assumed that the connectable path of FIG. 19 is the optimal path.

First, the difference calculation unit 154 identifies a terminal connected to the relay base station, that is, a terminal belonging to the relay base station in a direction from the terminal toward the root base station AP1. Referring to the optimal path in FIG. 19, the terminal AP1 belongs to the relay base station AP2, and the terminal STA2 and the terminal STA3 belong to the relay base station AP3.

Referring to the management table of RSSI values in FIG. 13, since only one terminal AP1 belongs to the relay base station AP2 to be evaluated, the minimum RSSI value is “−55” of the terminal STA1. On the other hand, the base stations grasped by the terminal STA1 are the root base station AP1 and the relay base station AP2, and the RSSI values are “−80” and “−46”, respectively. Here, the maximum RSSI value is “−46” of the relay base station AP2. Therefore, the difference d (AP2, STA1) between the maximum RSSI value and the minimum RSSI value is “−46−(−46)=0”.

Similarly, since the terminal STA2 is “−42” and the terminal STA3 is “−70” with respect to the relay base station AP3 to be evaluated, the minimum RSSI value is “−70” and the terminal is the terminal STA3. The base stations grasped by the terminal STA3 are the root base station AP1 and the relay base station AP3, and the RSSI values are “−95” and “−70”, respectively. The maximum RSSI value is “−70” of the relay base station AP2. Therefore, the difference d (AP3, STA3) between the maximum RSSI value and the minimum RSSI value is “−70−(−70)=0”.

Subsequently, when calculation is similarly performed for the unprocessed terminal STA2 belonging to the relay base station AP3, the difference d (AP3, STA2) is zero. Therefore, the sum d (AP3) of the differences for the relay base station AP3 is also zero.

Next, referring to the optimal path in FIG. 19, the relay base station AP2 and the relay base station AP3 belong to the root base station AP1 to be evaluated. Referring to the management table of RSSI values in FIG. 13, since the relay base station AP2 is “−55” and the relay base station AP3 is “−60” with respect to the root base station AP1, the minimum RSSI value is “−60” of the relay base station AP3. The base stations grasped by the relay base station AP3 are the root base station AP1 and the relay base station AP2, and the RSSI values are “−60” and “−57”, respectively. The maximum RSSI value is “−57” of the relay base station AP2. Therefore, the difference d (AP1, AP3) between the maximum RSSI value and the minimum RSSI value is “−57−(−60)=3”.

Subsequently, when calculation is similarly performed for the unprocessed relay base station AP2 belonging to the root base station AP1, the difference d (AP1, AP2) is zero. Therefore, the sum d (AP1) of the differences for the root base station AP1 is “3”. For the relay base station AP3, the radio field intensity of the relay base station AP2 is higher than that of the root base station AP1 in terms of the RSSI value. However, it can be said that it is determined that the relay base station AP3 should be connected to the root base station AP1 when the entire network of the multi-hop communication is viewed.

Therefore, the updated transmission power value p′ (k) is updated by adding “3” of d (AP1) from the default transmission power value. Note that the invention is not limited to updating the transmission power of the base station to be evaluated, and the transmission power of another base station having the maximum RSSI value may be updated. For example, in the above example, “3” of d (AP1) may be subtracted from the transmission power value of the relay base station AP2.

According to the present embodiment described above, RSSI value information and traffic information of the terminal and the relay base station are collected, one or more path candidates whose traffic does not exceed the maximum traffic amount are determined from one or more connectable paths that can be taken as the network configuration, and the optimal path is determined from the one or more path candidates. Even in a case where there is a constraint on the transmission time or the like of the terminal due to the Radio law or the like, the optimal path can be determined from the viewpoint of the fairness of traffic, and optimal route selection can be managed. In addition, a path candidate having the fairest duty ratio of the transmission time of the terminal can be determined as the optimal path. As a result, an optimal path can be determined from the viewpoint of fairness of power consumption caused by data transmission from each terminal. As a result, the throughput of the entire network can be improved while complying with laws and regulations.

In addition, even in a case where the terminal automatically determines the connection destination, by controlling the transmission power of the relay base station on the basis of the RSSI value, the terminal can be controlled to connect to the base station designated by the optimal path, and the optimal path can be selected.

Note that the present invention is not limited to the foregoing embodiments and various modifications can be made in the implementation stage without departing from the gist of the invention. In addition, each embodiment may be implemented in appropriate combination, and in that case, combined effects can be obtained. Furthermore, the embodiments described above include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

1 Communication system
2 Wireless communication system
100 Wireless communication management apparatus
101, 201, 301 Control circuit
102, 202, 302 Memory
103, 203 Wired communication module
104 User interface
105 Timer
106 Drive
107 Storage medium
111 User input unit
112, 211 Wired signal reception unit
113 Control information generation unit
114 Determination unit
115, 215 Wired signal transmission unit
116 Command library
151 Hop count calculation unit
152 Path calculation unit
153 Determination unit
154 Difference calculation unit
155, 214, 313 Update unit
200 Base station
204, 303 Wireless communication module
210 Relay base station
212, 311 Wireless signal reception unit
213, 312 Collection unit
216, 314 Wireless signal transmission unit
300 Terminal
304 Sensor
305 Battery
400 External server
500 Data server

1. A wireless communication management apparatus comprising a control circuit configured to:
calculate one or more path candidates based on wireless environment information collected from one or more relay base stations and a plurality of terminals configured to wirelessly communicate with a root base station, each of the path candidates being connectable paths that can be taken as a network configuration by multi-hop communication and indicating that a traffic amount of each relay base station included in the connectable paths is less than a threshold; and
determine one of the one or more path candidates as an optimal path.

2. The wireless communication management apparatus according to claim 1, wherein the control circuit determines, as the optimal path, a path candidate having the fairest duty ratio of a transmission time of the relay base station and the terminal.

3. The wireless communication management apparatus according to claim 1, wherein the control circuit is further configured to:
calculate a minimum hop count from the root base station to the connectable relay base station and a minimum hop count from the root base station to the connectable terminal or to the connectable terminal via the relay base station; and
calculate the path candidates with reference to the minimum hop count.

4. The wireless communication management apparatus according to claim 1, wherein when a traffic amount of at least one relay base station included in the connectable path is equal to or larger than a threshold, the control circuit decreases a traffic amount of a terminal that communicates with the at least one relay base station.

5. The wireless communication management apparatus according to claim 1, wherein the control circuit is further configured to:
calculate, for each of the terminals, a difference between a received signal strength value with the root base station or a first relay base station to be a connection destination in the optimal path and a maximum received signal strength value with a root base station or a second relay base station whose presence is recognizable by the terminal; and
update transmission powers of the first relay base station and the second relay base station using a sum of the differences of the terminals belonging to the first relay base station.

6. A wireless communication management method comprising:
calculating one or more path candidates based on wireless environment information collected from one or more relay base stations and a plurality of terminals configured to wirelessly communicate with a base station, each of the path candidates being connectable paths that can be taken as a network configuration by multi-hop communication and indicating that a traffic amount of each relay base station included in the connectable paths is less than a threshold; and
determining one of the one or more path candidates as an optimal path.

7. A non-transitory computer readable medium storing a program, when executed by a processor, causes the processor to perform a method comprising calculating one or more path candidates based on wireless environment information collected from one or more relay base stations and a plurality of terminals configured to wirelessly communicate with a root base station, each of the path candidate being connectable paths that can be taken as a network configuration by multi-hop communication and indicating that a traffic amount of each relay base station included in the connectable paths is less than a threshold; and
determining one of the one or more path candidates as an optimal path.
